(19) United States
(12) Patent Application Publication
(10) Pub. No.: US 2014/0026652 A1
(43) Pub. Date: Jan. 30, 2014

(54) SENSOR FOR MEASURING HIGH HUMIDITY CONDITIONS AND/OR CONDENSATION

(71) Applicants: Timothy Cummins, Cratloe (IE); John O. O'Connell, Mallow (IE)

(72) Inventors: Timothy Cummins, Cratloe (IE); John O. O'Connell, Mallow (IE)

(21) Appl. No.: 13/557,739

(22) Filed: Jul. 25, 2012

(51) Int. Cl. G01N 27/22

(52) U.S. Cl. 73/335.04

(57) ABSTRACT

A humidity sensor is provided having humidity levels approaching 100% relative humidity can be measured, as well as condensation measurements which appear as RH values “above 100%”. The humidity sensor is a capacitance based sensor. The capacitor(s) of the sensor is dimensioned so that substantial electric fields of the capacitor extend to the sensor/ambient air interface so that the conditions at the ambient side of the interface provide data for the sensor. In particular, the capacitance effects of moisture formation on the ambient side of the sensor/ambient air interface are utilized as part of the measurements so that relative humidity levels below and above 100% can be detected. The capacitor(s) of the sensor is dimensioned so that substantial electric fields of the capacitor extend to the air interface so that the conditions at ambient side of the interface provide data for the sensor.

### RELATED APPLICATIONS

This application is related to the following application, concurrently filed on the same date as the present application, U.S. patent application Ser. No. ______, entitled “Capacitive Sensor Comprising Differing Unit Cell Structures”; the disclosures of which is expressly incorporated by reference herein in its entirety.

### TECHNICAL

1. Field of the Invention

The techniques disclosed herein relate to humidity sensors, and more particularly humidity sensors which may also be utilized for condensation measurements.

2. Background

A wide variety of types of sensors are utilized to measure gases and other ambient air conditions such as humidity. When relative humidity concentrations rise to high levels, moisture condensation on surfaces may occur. Condensation such as the formation of “fogging” or actual water droplets on a surface is a well-known problem. Condensation initially may result in fogging of windows and surfaces, causing visibility problems and corrosion of metallic surfaces. Further increases in moisture cause the fog droplets to increase and eventually ‘coagulate’ into water drops or pools. This formation of water leads to shorting of electrical equipment, stagnant water pools in heating/ventilation/air-conditioning (HVAC) systems, etc. In health respiratory ventilator tubes and continuous positive airway pressure (CPAP) devices for example, the coagulation of condensate into water is called “rainout.” These pools of water forming in the ventilation tube can be especially dangerous if accidentally inhaled through the nose. Reliable detection of condensation is difficult, in particular the upward transition through the three phases of high-RH, fogging, rainout,—and the downward transition through the three phases as the situation reverses. One approach utilizes optical methods in which light is bounced off a surface and the reflected light characteristics are utilized to infer the presence of condensation. This technique can be expensive due to cost of components, assembly, and mounting, and it cannot easily discriminate between fogging and rainout. Another approach utilizes measuring the resistance between electrodes and detecting a reduced resistance or a short between the electrodes when water droplets are formed. This technique however may be unreliable, due to poor placement or incorrect mounting, and it cannot detect the early ‘fogging’ condensation phase. A third condensation measurement technique utilizes the combination of a relative humidity sensor and a temperature sensor to measure dew-point. With this technique, condensation is ‘inferred’ when the air temperature drops to become equal to the dew-point temperature. However this method is also problematic, as described in next paragraph

The use of many humidity sensors is also problematic as most humidity sensors cannot operate with condensation and often are explicitly prohibited from operation in condensing environments. Thus, many humidity sensors have operation limits of less than 95% relative humidity (RH) or even 90% RH. It is desirable in some applications however to have precise humidity measurements of RH greater than 95% and/or desirable to detect the actual presence of and amount of condensation. For example in health respiratory ventilators, in one exemplary embodiment continuous positive airway pressure (CPAP) devices, it may be desirable to operate at RH levels of in the range of 95-98%. A typical humidity sensor, designed for lower RH levels or for “non-condensing” conditions may not be suitable for such high RH level operations or for other applications where condensation may occur.

### SUMMARY OF THE INVENTION

In one exemplary, non-limiting, embodiment, a humidity sensor is provided in which condensing humidity levels approaching 100% relative humidity and even “above 100%” relative humidity may be measured , where readings “above 100%” correspond to varying amounts of condensate forming on the sensor The humidity sensor is a capacitance based sensor structure, measuring RH in the normal ranges of 0 to 100% RH. The capacitor(s) of the sensor structure is dimensioned so that substantial electric fields of the capacitor extend to the sensor/ambient air interface so that the conditions at the ambient side of the interface provide data for the capacitive sensor. In particular, the capacitance effects of moisture formation on the ambient side of the sensor/ambient air interface are utilized as part of the capacitance measurements so that the amount of condensate formation at relative humidity levels “above 100%” can be measured. The sensor can discriminate between fogging and rainout, therefore providing a continuous signal as the environment moves from normal RH to condensation/fogging, and then to ‘rainout’.

In one embodiment, a gas sensor is provided comprising a humidity sensitive dielectric material configured to provide a surface that may be exposed to an ambient air conditions. The gas sensor may further include a plurality of capacitor electrodes, the capacitive electrodes formed such that capacitive measurements of the humidity sensitive dielectric material may be obtained, the capacitive measurements of the humidity sensitive dielectric material being indicative of the humidity levels of the ambient air conditions. The plurality of capacitor electrodes are configured to provide electric fields between the capacitor electrodes, at least some of the electric fields extending beyond a surface of the humidity sensitive dielectric material that is exposed to ambient air conditions such that relative humidity levels of at least less than 95% may be detected from moisture that ingresses into the humidity sensitive dielectric material and relative humidity levels of greater than 100% may be indicated as a result of the at least some of the electric fields extending beyond the surface of the humidity sensitive dielectric material, the detection of relative humidity levels in excess of 100% being indicative of condensate forming on the sensor.

In another embodiment a method of configuring a humidity sensor is described. The method may include providing a humidity sensitive material that may be exposed to an ambient air condition and providing electrodes that may be configured to be used in the electrical detection of the ingress of moisture into the humidity sensitive material, the electrical detection providing for detection of humidity levels at least below 95% relative humidity levels in the ambient air condition. The method may further include configuring the humidity sensor to detect relative humidity levels of greater than 100%, wherein when such humidity levels are above 100%, the humidity sensor capable of detecting differing amounts of condensate formed on the surface of the humidity sensitive material.

### DESCRIPTION OF THE DRAWINGS

FIGS. 1A-1C illustrate exemplary capacitive humidity sensors.

FIG. 2 is illustrates exemplary capacitances formed in the capacitive humidity sensor of FIG. 1A.

FIG. 3 illustrates exemplary capacitances formed in the capacitive humidity sensor of FIG. 1C utilizing the capacitance effects of moisture formed on the sensor surface.

FIG. 3A illustrates a capacitance verse relative humidity curve.

FIG. 4 illustrates exemplary electric fields formed from a continuous moisture sheet on the surface of a capacitive humidity sensor.

FIG. 5 is an exemplary top plan view of interdigitated electrodes of a capacitive humidity sensor.

### DETAILED DESCRIPTION OF THE INVENTION

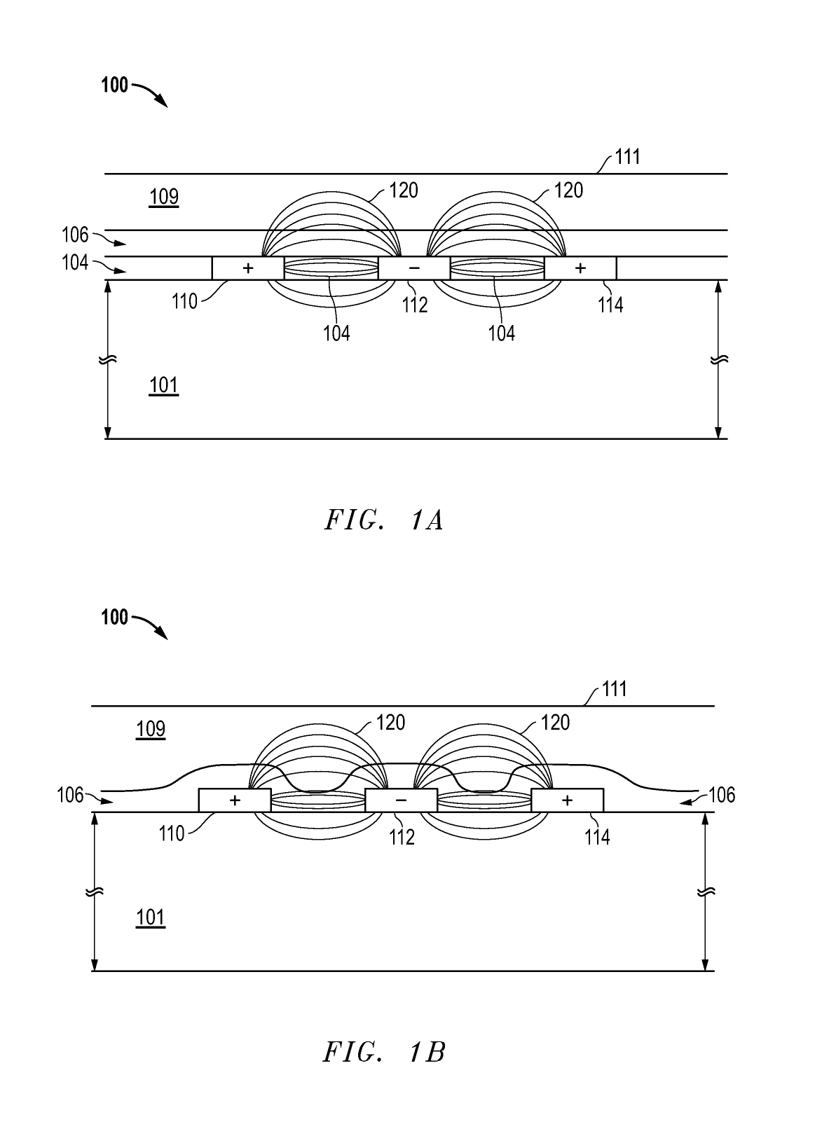

Rather than limiting use to lower RH ranges, the humidity and/or condensation sensor disclosed herein purposefully utilizes high RH condition measurements, even including condensation conditions. In one embodiment, the sensor may be a capacitive humidity sensor. FIGS. 1A-1C provide illustrative embodiments of a capacitive humidity sensor, though it will be recognized that many other capacitive humidity sensor structure arrangements may be utilized with the techniques disclosed herein. As shown in the FIG. 1A cross-section, sensor electrodes 110, 112 and 114 may be formed on a substrate 101 to form “fingers” of an interdigitated capacitive structure. It will be recognized that the capacitive structure may be formed by many electrodes arranged as shown in FIG. 1A. Capacitance measurements obtained between the electrodes may be utilized to determine humidity levels. Sensor electrodes may be any of a wide variety of conductive materials. Substrate 101 may be any of a wide variety of substrates and may be in one non-limiting example a semiconductor substrate that includes a wide variety of integrated circuit layers (not shown) as is known in the art. For example, U.S. Pat. No. 8,007,167 to Cummins provides a capacitive sensor formed on an integrated circuit substrate. The sensor electrodes may be formed in a layer 104, such as for example a silicon-dioxide layer 104. A passivation layer 106 (in one example a silicon nitride layer) may overlay the electrodes and then a sensor dielectric layer 109 (in one example a polyimide) may overlay the passivation layer 106. As shown in FIG. 1B, the layer 104 may be omitted in one embodiment. As further shown in FIG. 1C, both layers 104 and 106 may be omitted. In operation, the surface 111 of the sensor dielectric layer 109 is exposed to the ambient humidity conditions under which a measurement is desired. Thus, at least a portion of the upper surface 111 of the sensor dielectric layer 109 may be an air/dielectric layer interface and layer 109 may be considered an ambient humidity condition sensitive layer. The relative humidity in the ambient air changes the dielectric constant of the sensor dielectric layer as differing humidity concentrations in the ambient air will impact the amount of ingress of moisture into the sensor dielectric material. The absorption of moisture into the dielectric material will change the detected capacitance between the electrodes. By measuring the capacitance between the electrodes the humidity concentrations in the ambient air may be determined. As shown in FIGS. 1A-1C, the electric fields between the electrodes may include field lines 120. The electric fields between the electrodes will include components (such as in FIG. 1A) that pass through layer 104, components in layer 106 and components in layer 109 and even components in the substrate 101. In typical lower relative humidity operation, the changes in the sensor dielectric layer 109 caused by the ingress of humidity are the changes utilized to detect the ambient humidity conditions. Capacitor humidity sensor structures such as shown in FIGS. 1A-1C are known in the art, such as for example as shown in the aforementioned U.S. Pat. No. 8,007,167.

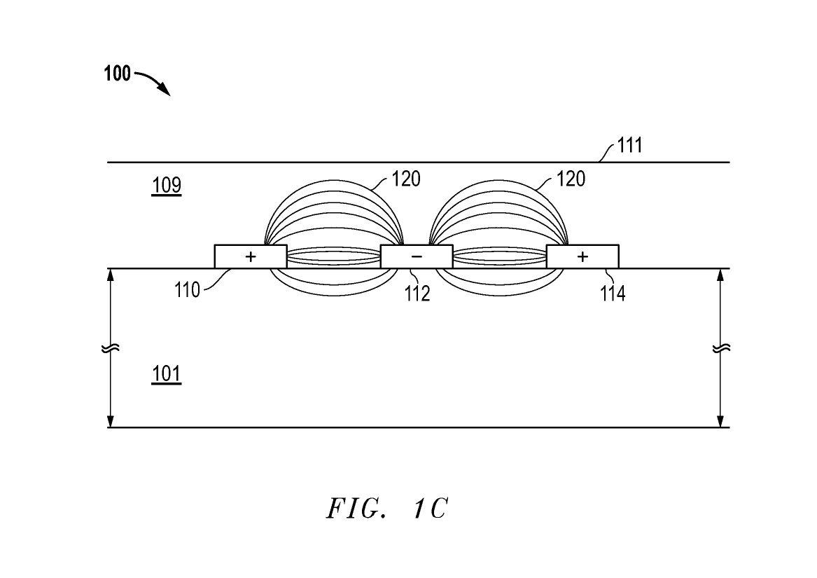

Thus, depending upon the sensor structure utilized the capacitance measured between the electrodes may be modeled to be comprised of the various capacitances of the various layers. For example, the embodiment of FIG. 2 illustrates exemplary capacitors formed by the structure of the embodiment of FIG. 1A. As shown in FIG. 2, the capacitance between the electrodes include components from modeled capacitors 200, 202, 204 and 206. Similar exemplary capacitance models may be shown for the exemplary embodiments of FIGS. 1B and 1C. In typical low humidity sensing conditions, the capacitance 206 of the sensor dielectric layer 109 would be expected to show the greatest variation with respect to the ambient humidity condition, such variation resulting from moisture ingressing into the sensor dielectric layer 109 from the ambient. However, it will be recognized that all of the various components of the capacitive measurement may be impacted by temperature changes, chemical contaminants, physical contaminants, etc., thus impacting the accuracy of the detection of the ambient conditions.

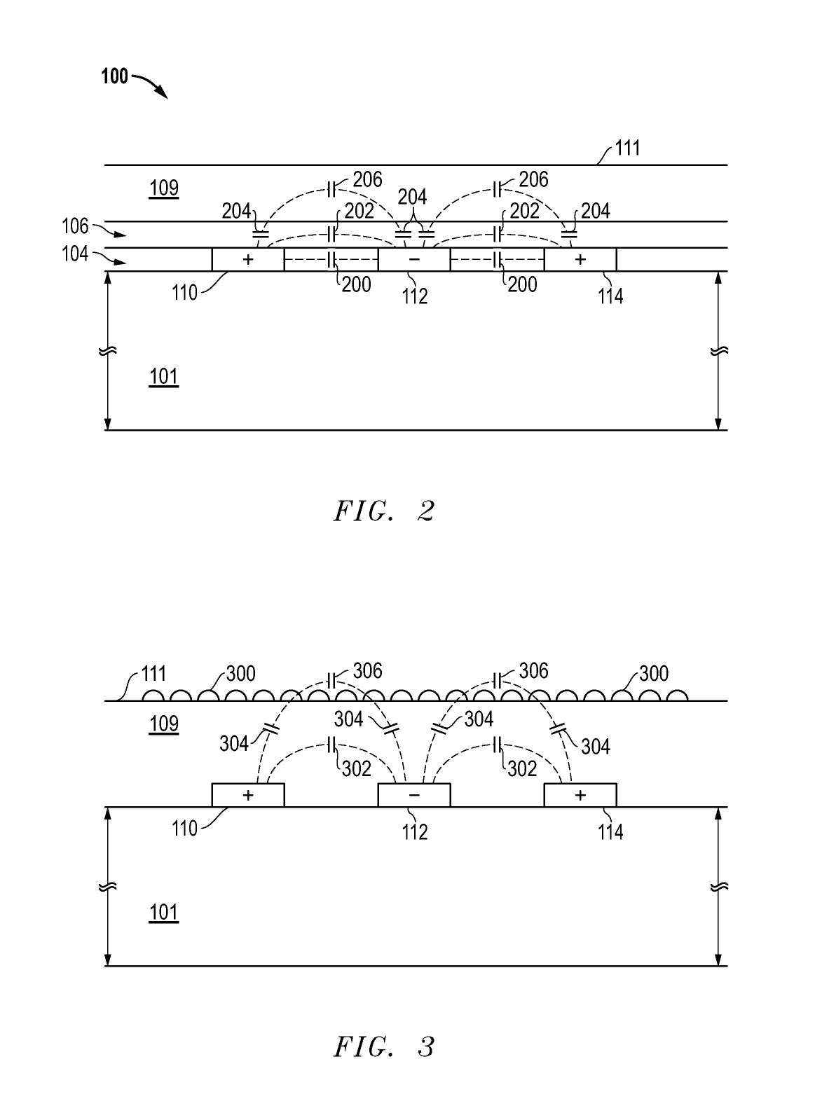

FIG. 3 illustrates an illustrative embodiment of a humidity sensor which may also detect condensation. For simplicity of drawing, FIG. 3 illustrates a capacitance model for sensor such as that of FIG. 1C in which layers 104 and 106 are not present. However, it will be recognized that the illustration of FIG. 3 is equally applicable to other capacitor models such as shown in FIG. 2. As shown in FIG. 3, condensation has begun to form on the surface 111 of the sensor dielectric layer 109, in the form of droplets 300. As shown in FIG. 3, with the addition of the condensation 300, an additional capacitance 306 is formed. Capacitance 306 is the additional capacitance resulting from moisture molecules on the surface of the sensor dielectric layer 109. More particularly, the high dielectric capacitance of water (80) causes a measurable increase in capacitance. Thus, the electric field lines in the sensor dielectric layer can also extend to detect water molecules on the surface 111. In this manner, the change in the detected capacitance can be utilized to detect the occurrence of condensation.

Furthermore, as the relative humidity increases to 100%, the system described herein may provide relative humidity readings greater than 100%. It will be recognized that the relative humidity in the ambient air conditions does not exceed 100%. However, the system and techniques described herein may provide humidity readings in excess of 100%. In such cases the excess above 100% is indicative of the density of the water molecules on the sensor surface and thus the measured “relative humidity” will increase above 100% as the water molecules increase and the further changes in the detected capacitance can be measured. In this fashion, “relative humidity measurements may provide readings up to 100% and beyond, for example, 120%, 140%, 160% etc. where the added portion above 100% corresponds to the extra capacitance 306 of the droplets 300. In this manner, as used herein relative humidity measurements above 100% are indicative of the amount of condensation on the sensor surface. The detected values of the measurement may continue to increase as the condensation increases. As described below, the detected measurements may continue to increase until the point of formation of a continuous water sheet, as which point the capacitance fields lines may be shorted and a steep drop in the detected humidity may occur.

In one embodiment, the changes in the capacitance can be correlated to the thickness of the water droplets and provide a resulting condensation measurement. For example, in one embodiment it has been found that each 1% RH increase above 100% RH corresponds to roughly 8.5 angstroms of moisture. Thus, in the described embodiment the formation of approximately an 850 angstrom thick fog or condensate has been found to correlate to approximately 200% RH reading by the measurement circuit.

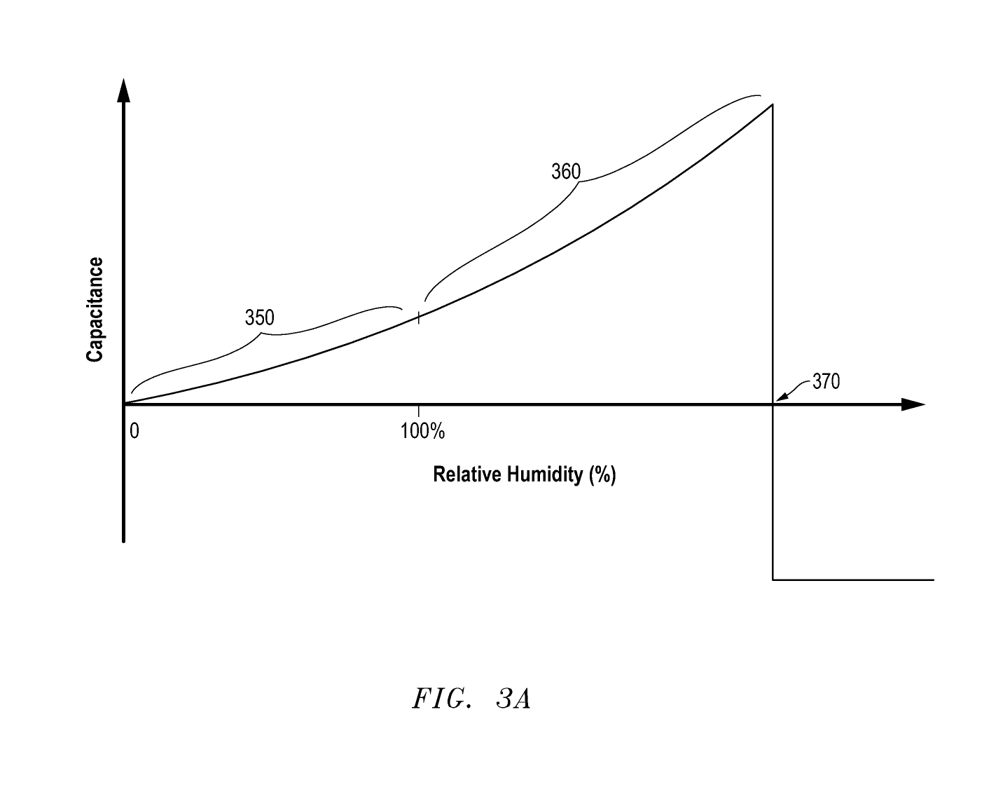

At some point, the condensate may become so dense so as to “join up” or “coagulate” into a continuous water sheet or droplet. In such a case, the water on the sensor surface appears as a capacitive ground plane. FIG. 4 illustrates a continuous water sheet 400 on the surface 111 of sensor dielectric layer 109. In such a condition, the field lines 402 gravitate to the water sheet 400, i.e. ‘shorted’ as if to a ground plane. At such point, the sensitivity of the sensor to relative humidity and condensation level may cease and the detected reading may reach a minimum. This is because nearly all of the field lines through the sensing layer become shorted to the low-impedance water-sheet on surface 111. For example, in one embodiment, the detected relative humidity level may reach a minimum, e.g. −400% RH, in such conditions.

As humidity conditions change and water evaporates off the surface, the detected measurements will change and when the surface no longer has moisture the detected measurement will drop to a sub 100% RH measurement, and the sensor continues normal operation. Therefore as the environment moves from normal RH (0-95% RH) into ‘fogging’ (95%-200%), the sensor provides a continuous signal to the control system, enabling smooth control and reversal, for example by additional air-conditioning. And in the event of water formation (‘rainout’), the sensor can also detect this, and trigger the appropriate system response, for example a dry-air purge.

The techniques provided herein thus provide a method of providing a continuous detection of relative humidity levels up to 100% and then also providing detected levels that exceed 100% with a continuous transition from the below 100% level to levels in excess of 100% (the excess indicating varying degrees of condensate on the sensor surface. FIG. 3A, provides an illustrative graph indicating capacitance measurements plotted verse the relative humidity. As shown in FIG. 3A, the detected capacitance changes in region 350 up to 100% relative humidity, indicating the increase in ambient relative humidity levels from 0 to 100%. The detected capacitances in region 360 provide a continuous measurement exceeding the 100% level, the measurements in this region corresponding to increased condensation. At point 370, a sharp drop in the detected capacitance indicates the formation of a continuous water sheet on the sensor surface.

To gain benefits of the capacitance effects that result from moisture formation upon the upper surface 111 as shown in FIG. 3, it is desirable for the electric fields associated with the electrodes to extend substantially to the surface region of the sensor dielectric layer. One factor impacting the extent of the electric fields is the periodicity of the electrodes (the period, P, being the width of the gap between the electrodes plus the width of the electrode). It is known that for typical sensor materials roughly 95% of the electric fields above the electrodes will be contained in a region of roughly P/2 above the sensor electrodes, where P is the period of the electrodes. Thus, for example with regard to the embodiment of FIG. 3, the dimensions of the electrodes 110, 112 and 114 and the thickness of the sensor dielectric may be configured in a manner such that the capacitance effects of the moisture on the surface 111 will have a measurable impact upon the detected capacitance between the electrodes. In this manner, moisture formation on the surface 111 may be detected and the detected capacitance may be correlated to a RH level at 100% RH or higher.

In one embodiment, the sensor electric fields may be configured in a manner such that traditional sensor measurements may be obtained for RH levels of 0-90% while at the same time sufficient electric fields may extend above the surface of the sensor dielectric layer such that RH levels of from 90-100% and even higher may be detected. The dimensions of the sensor dielectric layer and the electrode may be configured in such a manner such that sufficient electric fields both within the sensor dielectric layer and above the sensor dielectric layer may exist to provide RH readings in both the low level RH regions and the high level RH regions. In this manner a capacitive sensor may be provided that has an extended range for RH levels. In one range of embodiments, the sensor may be constructed in a manner such that the percentage of the electric field contained within the sensor dielectric is selected to be in a range of 60% to 95%. In one embodiment, approximately 80% of the electric field is within the sensor dielectric material, while approximately 20% extends above the surface. In one preferred range, the sensor dimensions may be configured to be in a range of 80% to 95% within the sensor dielectric. In another embodiment, greater than 5% of the electric fields extend above the sensor dielectric surface, and in a selected embodiment approximately at least 20% of the electric fields extend above the surface. Such techniques may provide a sensor sensitivity to lower (less than 90%) RH levels to sufficient accuracy while simultaneously providing measurement accuracy for the higher RH level, i.e., the response of the sensor can be tuned dynamically in operation to particular environmental conditions or applications.

In one embodiment, the sensitivity of the capacitance measurements at the surface 111 may be enhanced by removing the effects of the capacitances at the lower levels of the overall structure (such as, for example, capacitances 200 and 202 of FIG. 2). More particularly, one exemplary technique for removing such capacitances in the lower levels of the structure is described in, U.S. patent application Ser. No. ______, entitled “Capacitive Sensor Comprising Differing Unit Cell Structures” which is concurrently filed on the same date as the present application; the disclosure of which is expressly incorporated by reference herein in its entirety. In one embodiment of such technique, the sensor may be comprised of one or more first unit cells and one or more second unit cells. The first unit cell may be constructed to be different from the second unit cell. Moreover, the configuration of the unit cells is such that one unit cell may include capacitance effects of a humidity sensitive layer including capacitances at the upper surface of the humidity sensitive layer and other surrounding capacitance effects while the other unit cell includes the other surrounding capacitance effects but substantially does not include the capacitance effects at the upper surface layer of the humidity sensitive layer. By utilizing measurements from both unit cells, the capacitance effects of the humidity sensitive layer including the upper surface may be substantially isolated from the effects of the other surrounding capacitance effects. In one exemplary, non-limiting embodiment the utilization of measurements of both unit cells may include a capacitance subtraction process. In one exemplary, non-limiting embodiment the unit cells differ in their periodicity. Utilizing such techniques allows for a more sensitive measurement which isolates the impact of the capacitance changes in the regions of most interest that result as ambient humidity conditions change. It will be recognized, however, that the techniques described herein with regard to utilizing the moisture effects on the ambient/sensor interface are not limited to differing unit cell structure techniques and such differing unit cell techniques are merely exemplary. Thus, for example, the dimensions of the sensor may merely be configured in a manner such that the capacitance effects of moisture at the ambient/sensor interface may be detected in a manner that may be correlated to a given RH level without using the differing cell size technique.

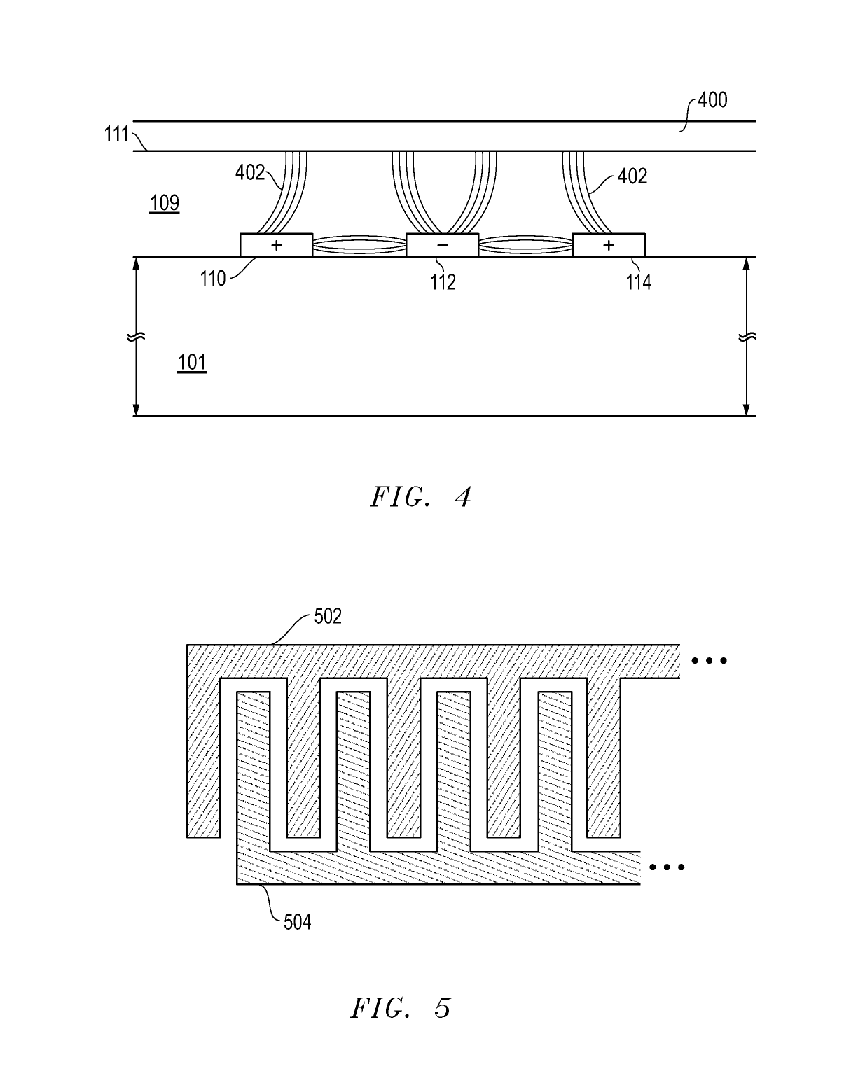

It will be recognized that the electrodes shown in the figures herein may be arranged in a wide range of layouts to provide a capacitance measurement between electrodes and the techniques described herein are not limited to any one particularly electrode layout. Thus, for example the cross sections of the electrodes of FIGS. 1-4 may be a portion of an interdigitated finger electrode layout, a simplified exemplary top view of such electrode layout being shown in FIG. 5. As shown in FIG. 5 a first electrode 502 (which corresponds to the electrodes 110 and 114 of FIGS. 1-4) may be interdigitated with a second electrode 504 (which corresponds to electrode 112 of FIGS. 1-4). As mentioned, FIG. 5 is merely illustrative of one type of electrode arrangement that may be utilized and many other variations of electrode arrangements may be equally suited for utilization of the capacitance measurement techniques described herein. Moreover, the techniques may be utilized with a sensor having one capacitor collecting data or more be utilized with a sensor that has a number of capacitors all collecting data.

Substrate 101 of the figures may be any of a wide variety of substrates and may be in one non-limiting example a semiconductor substrate that includes a wide variety of integrated circuit layers (not shown) as is known in the art. For example, U.S. Pat. No. 8,007,167 to Cummins, the disclosure of which is expressly incorporated herein by reference, provides a capacitive sensor formed on an integrated circuit (IC) substrate. The IC may include circuitry that provides processor capabilities, digital signal processing capabilities, analog to digital conversion capabilities, digital to analog conversion capabilities, programmability, memory storage and the like. Further, the IC may include other structures that may be useful for sensing, such as temperature sensors and heaters. In practice, all of these additional capabilities may be utilized together to correlate a detected capacitance value into a measured humidity value, to calibrate a humidity sensor for a given temperature, etc.

Thus, in one exemplary, non-limiting, embodiment, a humidity sensor is provided in which humidity levels approaching 100% relative humidity and even above 100% relative humidity may be detected. The humidity sensor is a capacitance based sensor structure. The capacitor(s) of the sensor structure is dimensioned so that substantial electric fields of the capacitor extend to the sensor/ambient air interface so that the conditions at the ambient side of the interface provide data for the capacitive sensor. In particular, the capacitance effects of moisture formation on the ambient side of the sensor/ambient air interface are utilized as part of the capacitance measurements so that relative humidity levels above 100% can be detected. The capacitor(s) of the sensor structure is dimensioned so that substantial electric fields of the capacitor extend to the sensor/ambient air interface so that the conditions at the ambient side of the interface provide data for the capacitive sensor. Because the humidity sensor is designed to allow measurements even in the presence of moisture formation on the sensor surface, the humidity sensor may be utilized to measure very high sub 100% RH levels (for example 95% or higher or even 98% or higher) or even RH levels above 100% . Thus, the humidity sensor disclose herein does not have to be limited to a lower RH level operation as many known sensors are limited.

A wide range of materials may be utilized for the various components of the humidity sensor described herein while still gaining the benefits described herein. Exemplary humidity sensitive materials for use as the sensor layer 109 include BDMA (benzyldimethylamine), and other polyimides types, such as PBOs, BCB and the like. The electrodes may be formed from a wide range of conductive materials including aluminum, copper, refractory metals or other conductive materials as known in the art. In one exemplary embodiment of the example of FIG. 3 the sensor dielectric layer 109 may be a polyimide having a thickness of 3.6 microns and the electrodes may have a thickness of 1.0 micron and be formed of aluminum, gold, titanium, copper, refractory metals, or any other conductor material as known for potential use in integrated circuit manufacturing. In this exemplary embodiment, for measurements that are intended to include the capacitance effects at the surface 111 of the sensor dielectric layer 109, the electrodes may be formed having a width of 6 microns and gap of 3 microns. In various other embodiments, the sensor dielectric may range from 1 to 10 microns and the electrodes may be selected to have a width of between 2 and 10 and a gap of between 1 and 5. As will be recognized, other combinations of the structural dimensions of the dielectric layer and the electrodes may be utilized to provide the desired effect of having a significant amount (i.e. greater than two percent) of the electric field extend above the sensor dielectric surface.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein and certain features of the invention may be utilized independently of the use of other features, all as would be apparent to one skilled in the art after having the benefit of this description of the invention.

1. A humidity sensor comprising:
a humidity sensitive dielectric material having a surface that may be exposed to ambient air conditions; and
a plurality of capacitor electrodes, the capacitive electrodes formed such that capacitive measurements of the humidity sensitive dielectric material may be obtained, the capacitive measurements being indicative of the humidity levels of the ambient air conditions;
the plurality of capacitor electrodes configured to provide electric fields between the capacitor electrodes, at least some of the electric fields extending beyond a surface of the humidity sensitive dielectric material that is exposed to ambient air conditions such that relative humidity levels of less than 95% may be detected from moisture that ingresses into the humidity sensitive dielectric material and relative humidity levels of greater than 100% may be indicated as a result of the at least some of the electric fields extending beyond the surface of the humidity sensitive dielectric material, the detection of relative humidity levels in excess of 100% being indicative of condensate forming on the humidity sensor.

2. The humidity sensor of claim 1, wherein the capacitor electrodes are spaced such that at least 5% of the electric fields between the capacitor electrodes extend beyond the surface of the humidity sensitive material that is exposed to the ambient air condition.

3. The humidity sensor of claim 2, wherein the capacitor electrodes are spaced such that between 5% and 20% of the electric fields between the capacitor electrodes extend beyond the surface of the humidity sensitive material that is exposed to the ambient air condition.

4. The humidity sensor of claim 1, wherein the humidity sensor detects differing amounts of condensate on the humidity sensitive dielectric material surface.

5. The humidity sensor of claim 4, wherein the differing amounts of condensate include at least fogging and the formation of a continuous water sheet.

6. The humidity sensor of claim 1, wherein the humidity sensor provides continuous detection of relative humidity levels from below 90% relative humidity to relative humidity levels above 100%.

7. The humidity sensor of claim 6, wherein the capacitor electrodes are spaced such that between 5% and 20% of the electric fields between the capacitor electrodes extend beyond the surface of the humidity sensitive material that is exposed to the ambient air condition.

8. The humidity sensor of claim 1, the humidity sensitive dielectric material overlaying the plurality of capacitor electrodes.

9. The humidity sensor of claim 1, the humidity sensor providing a continuum of humidity measurements from measurement levels less than 100% relative humidity to levels greater than 100%.

10. The humidity sensor of claim 9, the humidity sensor providing capacitive measurements having a measurement transition indicative of the formation of a continuous film of water on the humidity sensitive dielectric material surface.

11. The humidity sensor of claim 1, the humidity sensor providing capacitive measurements having a measurement transition indicative of the formation of a continuous film of water on the humidity sensitive dielectric material surface.

12. A method of configuring a humidity sensor, comprising:
providing a humidity sensitive material that may be exposed to an ambient air condition;
providing electrodes that may be configured to be used in the electrical detection of the ingress of moisture into the humidity sensitive material, the electrical detection providing for detection of humidity levels at least below 95% relative humidity levels in the ambient air condition; and
configuring the humidity sensor to detect relative humidity levels of greater than 100%, the detection of relative humidity levels in excess of 100% being indicative of condensate forming on the humidity sensor.

13. The method of claim 12, wherein the differing amounts of condensate include at least fogging and the formation of a continuous water sheet.

14. The method of claim 12, wherein the electrodes are capacitor electrodes and the humidity levels both above and below 100% are detected by monitoring capacitive changes between the electrodes.

15. The method of claim 14, wherein the capacitor electrodes are formed so that substantial electric fields of the capacitor electrodes extend beyond a surface of the humidity sensitive material that is exposed to the ambient air condition.

16. The method of claim 14, wherein at least 5% of the electric field between the capacitor electrodes extend beyond the surface of the humidity sensitive material that is exposed to the ambient air condition.

17. The method of claim 16, wherein between 5% and 20% of the electric field between the capacitor electrodes extend beyond the surface of the humidity sensitive material that is exposed to the ambient air condition.

18. The method of claim 17, wherein the differing amounts of condensate comprise of at least fogging and the formation of a continuous water sheet.

19. The method of claim 14, wherein the differing amounts of condensate comprise of at least fogging and the formation of a continuous water sheet.

20. The method of claim 12, wherein the humidity sensor provides continuous detection of relative humidity levels from below 90% relative humidity to relative humidity levels above 100%.

21. The method of claim 12, wherein the humidity sensitive material is a dielectric.

22. The method of claim 21, wherein the electrodes are capacitor electrodes and at least 20% of the electric fields between the capacitor electrodes extend beyond the surface of the humidity sensitive material that is exposed to the ambient air condition.

23. The method of claim 21, wherein the electrodes are capacitor electrodes and between 5% and 20% of the electric fields between the capacitor electrodes extend beyond the surface of the humidity sensitive material that is exposed to the ambient air condition.

24. The method of claim 21, wherein the electrodes are capacitor electrodes, the capacitor electrodes being configured to be utilized for detection of relative humidity levels both above and below 100% relative humidity.

25. The method of claim 12, further comprising providing a continuum of humidity measurements from measurement levels less than 100% relative humidity to levels greater than 100%.

26. The method of claim 25, further comprising providing capacitive measurements having a measurement transition indicative of the formation of a continuous film of water on the humidity sensitive dielectric material surface.

27. The method of claim 12, further comprising providing capacitive measurements having a measurement transition indicative of the formation of a continuous film of water on the humidity sensitive dielectric material surface.
